(19) United States
(12) Patent Application Publication
(10) Pub. No.: US 2010/0288100 A1
(43) Pub. Date: Nov. 18, 2010

(54) Cutting Frame of Low Cutting Loss Ratio

(75) Inventors: Hokyung Lee, Daejeon (KR); Jaein Choi, Daejeon (KR); Soonki Heo, Daejeon (KR)

Correspondence Address: MCKENNA LONG & ALDRIDGE LLP, 1900 K STREET, NW, WASHINGTON, DC, 20006, US

(73) Assignee: LG CHEM, LTD., Seoul (KR)

(21) Appl. No.: 12/677,061

(22) PCT Filed: Aug. 27, 2008
(86) PCT No.: PCT/KR2008/005003

§ 371 Date: Jun. 16, 2010

(30) Foreign Application Priority Data
Sep. 8, 2007 (KR) 10-2007-0091265

(51) Int. Cl. B26D 1/00

(52) U.S. Cl. 83/859

(57) ABSTRACT

Disclosed herein is a cutting frame including a plurality of cutters for cutting one or more kinds of rectangular unit pieces having a relatively small size from a rectangular base material at a predetermined inclination, the cutters being mounted or formed in the cutting frame such that the cutters correspond to the rectangular unit pieces, wherein the cutters are mounted or formed in the cutting frame in an array structure of the rectangular unit pieces in which the rectangular unit pieces adjacent to one another at each side thereof have a vertex coincidence ratio equivalent to less than 50%.

### FIELD OF THE INVENTION

The present invention relates to a cutting frame of a low cutting loss ratio, and, more particularly, to a cutting frame including a plurality of cutters for cutting one or more kinds of rectangular unit pieces having a relatively small size from a rectangular base material at a predetermined inclination, the cutters being mounted or formed in the cutting frame such that the cutters correspond to the rectangular unit pieces, wherein the cutters are mounted or formed in the cutting frame in an array structure of the rectangular unit pieces in which the rectangular unit pieces adjacent to one another at each side thereof have a vertex coincidence ratio equivalent to less than 50%.

### BACKGROUND OF THE INVENTION

A technology for cutting a rectangular base material having a relatively large size to manufacture a plurality of rectangular unit pieces having relatively small sizes has been adopted in various fields. For example, a base material sheet having a predetermined width and a long length is repeatedly cut by a cutting frame to simultaneously manufacture a plurality of rectangular unit pieces though a one-time cutting process.

Meanwhile, the size (width) of the base material is specified, whereas the size of the rectangular unit pieces may vary as needed, due to various factors, such as the limitation of base material suppliers, the efficiency aspect of the manufacturing process, the fluctuation in demand of rectangular unit pieces, etc. In this case, the cutting efficiency greatly varies depending upon in which structure the cutting frame is constructed, i.e., in which structure cutters for cutting the rectangular unit pieces from the base material are arranged, when cutting a plurality of desired rectangular unit pieces based on the size of the base material. The low cutting efficiency increases the amount of scrap, produced from the base material, which will be disposed of after the cutting process, with the result that eventually, the manufacturing costs of the rectangular unit pieces increase.

When the size (width and length) of a base material is in constant proportion to the size (lateral length and longitudinal length) of specific rectangular unit pieces, it is possible to minimize the cutting loss by sequentially arranging the rectangular unit pieces such that the rectangular unit pieces are brought into contact with one another at positions having such constant proportion. However, when such constant proportion is not formed, the cutting loss may vary depending upon the array structure of the rectangular unit pieces.

Furthermore, when the rectangular unit pieces are to be cut at a predetermined angle to the longitudinal direction of the base material, a large amount of scrap is inevitably produced.

In order to cut the rectangular unit pieces at the predetermined angle, there is generally used an array structure in which cutters (for example, knives) are arranged in the cutting frame such that the rectangular unit pieces corresponding to the cutters are adjacent to one another.

In connection with this matter, FIGS. 1 and 2 typically illustrate a conventional cutting frame in which rectangular unit pieces are located on a base material to construct cutters corresponding to the rectangular unit pieces. For convenience of description, the base material is illustrated to have a predetermined length.

Referring to these drawings, a plurality of desired rectangular unit pieces 20 are cut from a base material sheet 10 having a predetermined width and a long length. In a cutting frame 30 are arranged a plurality of cutters 32 corresponding to the rectangular unit pieces 20. Consequently, the array structure of the rectangular unit pieces 20 is substantially identical to that of the cutters 32.

The cutters 32 are mounted or formed in the cutting frame 30 such that the cutters 32 can cut a predetermined number (six in FIG. 1 and eight in FIG. 2) of the rectangular unit pieces 20 through a one-time cutting process. Consequently, the base material sheet 10 is cut by the cutting frame 30, and then the base material sheet 10 is cut again by the cutting frame 30 while the base material sheet 10 is overlapped by a predetermined length s in the longitudinal direction of the base material sheet 10. In this way, a series of cutting processes are carried out.

Each rectangular unit piece 20 is constructed in a rectangular structure in which a longitudinal side a of each rectangular unit piece 20 is longer than a lateral side b of each rectangular unit piece 20. Also, each rectangular unit piece 20 is inclined at an angle a of approximately 45 degrees to the longitudinal direction of the base material sheet 10. When the inclined rectangular unit pieces 20 are arranged on the base material sheet 10, it is possible to generally consider two array structures of the rectangular unit pieces as shown in FIGS. 1 and 2.

The first array structure of the rectangular unit pieces is to sequentially arrange the rectangular unit pieces such that the lateral sides b of the respective rectangular unit pieces coincide with one another, as shown in FIG. 1. According to this array structure, it is possible to cut a total of 24 rectangular unit pieces 20 from a base material sheet 10 having an effective width W and length L. However, it is not possible to cut a rectangular unit piece 21 located at a position deviating from the effective width W of the base material sheet 10.

In this array structure, only a cutting width D, not the effective width W, of the base material sheet 10 is substantially used, and therefore, the remaining width W-D is disposed of as scrap. Since the rectangular unit pieces 20 are inclined at an angle of approximately 45 degrees, scrap is also inevitably produced at the upper end region of the base material sheet 10.

The second array structure of the rectangular unit pieces is to sequentially arrange the rectangular unit pieces such that the longitudinal sides a of the respective rectangular unit pieces coincide with one another, as shown in FIG. 2. According to this array structure, it is possible to cut a total of 19 rectangular unit pieces 20 from a base material sheet 10 having an effective width W and length L.

In consideration of the above description, it can be seen that the cutting efficiency may vary according to the array structure of the rectangular unit pieces. However, when the rectangular unit pieces are inclined at a specific angle to the base material sheet, it is not easy to arrange the rectangular unit pieces in various array structures. For this reason, only the array structure of the rectangular unit pieces in which specific sides (longitudinal sides or lateral sides) of the respective rectangular unit pieces coincided with one another as shown in FIG. 1 or 2 is mainly considered in the conventional art.

Consequently, when an array structure of the rectangular unit pieces exhibiting higher cutting efficiency than that of the array structures of the rectangular unit pieces as shown in FIGS. 1 and 2 is provided, it is possible to lower the cutting loss and eventually reduce the manufacturing costs of products. The improvement of the cutting efficiency is more and more serious especially when the price of the base material is high and/or the rectangular unit pieces are to be manufactured on a large scale.

### SUMMARY OF THE INVENTION

Therefore, the present invention has been made to solve the above problems, and other technical problems that have yet to be resolved.

As a result of a variety of extensive and intensive studies and experiments on a cutting frame, the inventors of the present invention have found that, when cutters are formed in a specific array structure of rectangular unit pieces, which will be hereinafter described in detail, such that the cutters correspond to the respective rectangular unit pieces, the cutting loss ratio is lowered as compared with the conventional array structure of the rectangular unit pieces. The present invention has been completed based on these findings.

Specifically, it is an object of the present invention to provide a cutting frame including cutters formed to exhibit a low cutting loss ratio when cutting a plurality of rectangular unit pieces inclined at a predetermined angle to the longitudinal direction of a rectangular base material having a relatively large size from the rectangular base material.

It is another object of the present invention to provide a scrap having bores corresponding to the rectangular unit pieces arranged in the array structure of the rectangular unit pieces exhibiting the low cutting loss ratio as described above.

In accordance with one aspect of the present invention, the above and other objects can be accomplished by the provision of a cutting frame including a plurality of cutters for cutting one or more kinds of rectangular unit pieces having a relatively small size from a rectangular base material at a predetermined inclination, the cutters being mounted or formed in the cutting frame such that the cutters correspond to the rectangular unit pieces, wherein the cutters are mounted or formed in the cutting frame in an array structure of the rectangular unit pieces in which the rectangular unit pieces adjacent to one another at each side thereof have a vertex coincidence ratio equivalent to less than 50%.

Consequently, the cutting frame according to the present invention is constructed in a structure in which, although the rectangular unit pieces are arranged while being adjacent to one another as shown in FIGS. 1 and 2, one side of one rectangular unit piece does not completely coincide with, but is somewhat offset from, the corresponding side of another rectangular unit piece. In this unique array structure of the rectangular unit pieces, an island-type residue is formed among adjacent four rectangular unit pieces.

This array structure of the rectangular unit pieces is not the structure that can be generally easily considered when the cutters are arranged on the base material to cut inclined rectangular unit pieces. However, it was confirmed that this unique array structure of the rectangular unit pieces provides lower cutting loss ratio (or higher cutting efficiency) than the conventional cutting frame to our surprise.

The cutting frame according to the present invention exhibits lower cutting loss ratio than the conventional cutting frame by the unique array structure of the rectangular unit pieces as defined above because the unit pieces are constructed in a rectangular structure, and the rectangular unit pieces are cut while being inclined at a predetermined angle to the longitudinal direction of the base material.

The inventors of the present invention confirmed that, when the unit pieces are constructed in a square structure or the unit pieces are cut while not being inclined, the cutting efficiency is further improved by an array structure in which the unit pieces are arranged while being adjacent to one another such that the opposite sides coincide with one another. Consequently, the cutting frame according to the present invention is preferably used to cut the rectangular unit pieces while the rectangular unit pieces are inclined at a predetermined angle.

In the above description, the ‘the vertex coincidence ratio’ means a ratio in which four vertexes of one rectangular unit piece coincide with vertexes of other rectangular unit pieces adjacent to the one rectangular unit piece at each side thereof in a series of the rectangular unit pieces arranged at the rectangular base material.

In the array structure of the rectangular unit pieces according to the conventional art, two sides of each rectangular unit piece, among four sides of each rectangular unit piece, are adjacent to two other rectangular unit pieces for each side, and the remaining two sides of each rectangular unit piece are adjacent to another rectangular unit piece for each side. According to the conventional art, therefore, the number of other rectangular unit pieces to which each rectangular unit piece can be adjacent is six (see FIG. 1) or five (see FIG. 2). At this time, the remaining two sides of each rectangular unit piece are adjacent to another rectangular unit piece for each side, with the result that the vertexes of the two rectangular unit pieces coincide with each other. At the regions where the two sides of each rectangular unit piece are adjacent to two other rectangular unit pieces for each side, on the other hand, the vertexes of the opposite ends of the adjacent sides do not coincide with each other. Consequently, the vertex coincidence ratio is calculated to be approximately 66% in the array structure of the rectangular unit pieces.

In consideration of this matter, the rectangular unit pieces are somewhat offset from one another such that each side of any arbitrary rectangular unit piece is adjacent to only another rectangular unit piece in the array structure of the rectangular unit pieces according to the present invention. In this array structure of the rectangular unit pieces in which rectangular unit pieces are somewhat offset from one another, the vertexes of the respective rectangular unit pieces adjacent to one another at each side thereof do not coincide with one another. When all the rectangular unit pieces are arranged in the array structure of the rectangular unit pieces, the vertex coincidence ratio is 0%.

The inventors of the present invention have prepared and examined various array structures of the rectangular unit pieces and found out that, when the rectangular unit pieces are arranged such that the rectangular unit pieces adjacent to one another at each side thereof have a vertex coincidence ratio equivalent to less than at least 50%, i.e., a vertex non-coincidence ratio equivalent to not less than 50%, it is possible to reduce the cutting loss ratio to be lower than that achieved by the conventional array structure of the rectangular unit pieces.

Consequently, when it is considered that the vertex coincidence ratio of the rectangular unit pieces is approximately 66% in the conventional array structure of the rectangular unit pieces as shown in FIGS. 1 and 2, the cutting frame according to the present invention is constructed in a structure in which at least some rectangular unit pieces are arranged such that the vertexes of the at least some rectangular unit pieces do not coincide with those of the rectangular unit pieces adjacent to the at least some rectangular unit pieces, and, when the vertex coincidence ratio is less than 50%, the cutting frame according to the present invention exhibits lower cutting loss ratio.

In a preferred embodiment, when the rectangular unit pieces are arranged, such that the vertex coincidence ratio is 0%, in an array structure in which only one kind of the rectangular unit pieces are arranged, it is possible to obtain the lowest cutting loss ratio. On the other hand, when two or more kinds of the rectangular unit pieces are arranged, the optimum array structure of the rectangular unit pieces may be provided in consideration of the ratio in size of the rectangular unit pieces to one another or the ratio in size of the rectangular unit pieces to the base material. In this array structure of the rectangular unit pieces, the lowest cutting loss ratio may be exhibited although the vertex coincidence ratio is 0%. In this case, however, it is required for the vertex coincidence ratio not to exceed 50%.

One of the reasons why the array structure of the rectangular unit pieces according to the present invention exhibits relatively low cutting loss ratio is that the rectangular unit pieces are arranged such that the vertexes of the respective rectangular unit pieces adjacent to one another at each side thereof do not coincide with one another, whereby it is possible to maximize the cutting width of the rectangular unit pieces with respect to the width of the rectangular base material.

In the present invention, the coincidence of the vertexes means that x and y values (Ax, Ay) of one rectangular unit piece (A) coincide with x and y values (Bx, By) of another rectangular unit piece (B) adjacent to the rectangular unit piece (A) at one side thereof in an array coordinate system of the rectangular unit pieces. Accordingly, the non-coincidence of the neighboring vertexes means that x and y values (Ax, Ay) of one rectangular unit piece (A) do not coincide with x and y values (Bx, By) of another rectangular unit piece (B) adjacent to the rectangular unit piece (A) at one side thereof in an array coordinate system of the rectangular unit pieces. In the present invention, however, the coincidence does not mean geometrically full coincidence. Consequently, the non-coincidence may have a deviation equivalent to, for example, 0.5% or more of the effective width of the base material.

In the present invention, the base material may be a separate single material on which one-time or several-time cutting processes can be carried out or a continuous material having a predetermined width and a relatively very long length. The latter may be a long base material sheet. In this case, the base material sheet may be unwound from a roller, and the unwound base material sheet is sequentially cut by the cutting frame. In consideration of the manufacturing production efficiency and economical efficiency of the rectangular unit pieces, the base material is preferably a continuous material.

As previously described, all the rectangular unit pieces are cut from the base material while being inclined at a predetermined angle to the longitudinal direction of the base material. The rectangular unit pieces may be cut while being inclined at the predetermined angle to the base material, for example, when inherent physical properties of the base material in the longitudinal direction or in the lateral direction must be expressed by a predetermined angle with respect to the rectangular unit pieces. For example, the rectangular unit pieces may be inclined at an angle of 20 to 70 degrees.

In a preferred embodiment, the base material is a film including layers (‘absorption layers or transmission layers’) that absorb or transmit only a specific-direction wave motion of light or an electromagnetic wave in the longitudinal direction or in the lateral direction, and the rectangular unit pieces cut from the base material is a relatively small-sized film of which the absorption layers or the transmission layers are inclined at an angle of 45 degrees.

In the present invention, the array structure of the rectangular unit pieces substantially coincide with the cutters of the cutting frame or the array structure of the cutters. Consequently, it is interpreted that the array structure of the rectangular unit pieces means the cutters or the array structure of the cutters, so long as an additional description is not given.

The kind of the cutters is not particularly restricted so long as the cutters exhibit the structure or properties to cut the rectangular unit pieces from the base material. Typically, each of the cutters may be a knife for cutting, such as a metal knife or a jet water knife, or a light source for cutting, such as laser.

In a preferred embodiment, all the rectangular unit pieces located in the longitudinal direction (X-axis direction: horizontal direction) of the base material are arranged such that the upper end heights of the rectangular unit pieces are the same. When the upper end heights of the rectangular unit pieces are the same, for example, a marking process to distinguish between the upper and lower sides of the cut rectangular unit pieces is more easily carried out than in case where the upper end heights of the rectangular unit pieces are different, thereby improving productivity.

In a preferred embodiment, the rectangular unit pieces are arranged such that the distances between the leftmost end rectangular unit pieces and the rightmost end rectangular unit pieces at heights from the lower end of the cutting frame are the same irrespective of the heights. Consequently, it is possible to minimize the production of a scrap in the longitudinal direction of the base material when performing a series of repetitive cutting processes.

More preferably, the cutting frame is constructed such that the left boundary shape of the rectangular unit pieces coincides with the right boundary shape of the rectangular unit pieces. In this case, no scrap is produced in the longitudinal direction of the base material, thereby further reducing the cutting loss ratio.

In accordance with another aspect of the present invention, there is provided a scrap obtained after cutting one or more kinds of rectangular unit pieces from a base material at a predetermined inclination.

Specifically, the scrap according to the present invention is constructed in a structure in which a plurality of bores corresponding to the rectangular unit pieces are continuously connected to one another by a cutting margin, and the rectangular unit piece bores are arranged such that the rectangular unit piece bores adjacent to one another with a cutting margin corresponding to each side of the rectangular unit piece bores have a vertex coincidence ratio equivalent to less than 50%.

The scrap according to the present invention exhibits a unique shape not expected from the conventional art, thereby achieving lower cutting loss ratio with respect to the same-sized base material than the conventional art.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are typical views illustrating a conventional cutting frame in which rectangular unit pieces are located on a base material to construct cutters corresponding to the rectangular unit pieces;

FIG. 3 is a typical view illustrating a cutting frame according to a preferred embodiment of the present invention in which one kind of rectangular unit pieces are located on a base material to construct cutters corresponding to the rectangular unit pieces;

FIG. 4 is a typical view illustrating a cutting frame according to a preferred embodiment of the present invention; and

FIG. 5 is a typical view partially illustrating the shape of a scrap according to a preferred embodiment of the present invention.

### DETAILED DESCRIPTION OF PREFERRED EMBODIMENTS

Now, preferred embodiments of the present invention will be described in detail with reference to the accompanying drawings. It should be noted, however, that the scope of the present invention is not limited by the illustrated embodiments.

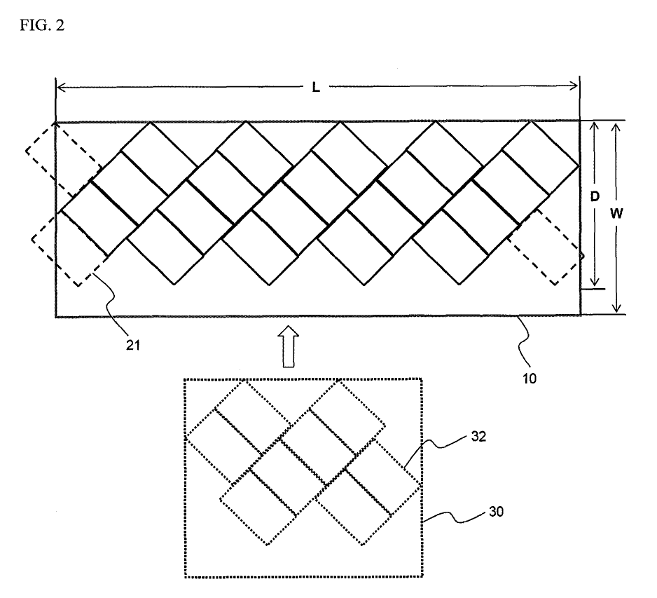

FIG. 3 is a typical view illustrating a cutting frame according to a preferred embodiment of the present invention in which one kind of rectangular unit pieces are located on a base material to construct cutters corresponding to the rectangular unit pieces.

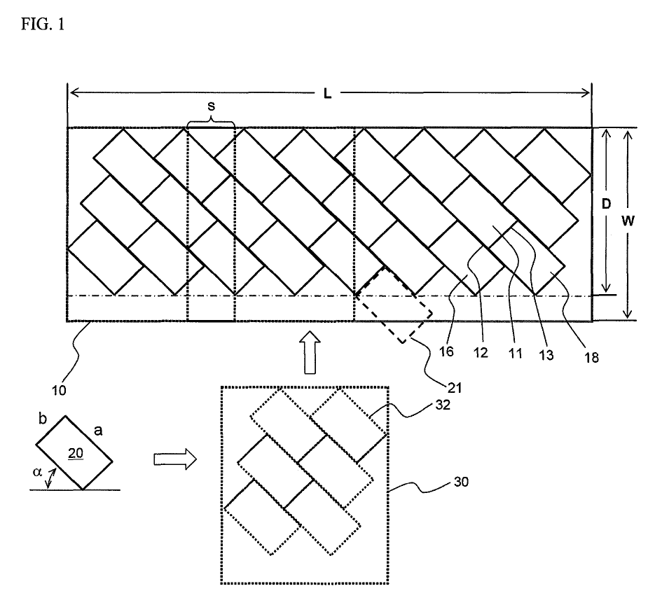

Referring to FIG. 3, the rectangular unit pieces are arranged in an array structure in which one rectangular unit piece 200 is adjacent to other rectangular unit pieces 210 and 230 at two sides thereof but is not adjacent to another rectangular unit piece 220. In comparison with this array structure, one rectangular unit piece is in contact with six rectangular unit pieces in the array structure of the rectangular unit pieces as shown in FIG. 1, and one rectangular unit piece is in contact with five rectangular unit pieces in the array structure of the rectangular unit pieces as shown in FIG. 2. Consequently, some sides of the rectangular unit pieces are simultaneously in contact with two other rectangular unit pieces in the array structures of the rectangular unit pieces as shown in FIGS. 1 and 2. For reference, FIG. 3 illustrates that only the three rectangular unit pieces 210, 220, and 230 are located around the rectangular unit piece 200.

Meanwhile, the rectangular unit piece 200 has a vertex 201, which is spaced by a predetermined deviation d from corresponding vertexes 211 and 231 of the rectangular unit pieces 210 and 230 which are adjacent to the rectangular unit piece 200 at one side of each rectangular unit piece. That is, all the vertexes of the rectangular unit pieces 200, 210, 220, and 230 are spaced by the deviation d from one another, and the rectangular unit pieces 200, 210, 220, and 230 have no vertexes coinciding with one another. In this case, therefore, a ratio in which the vertexes coincide with one another (vertex coincidence ratio) is 0%.

In the array structure of the rectangular unit pieces, on the other hand, the vertexes of one rectangular unit piece 11 do not coincide with the vertexes of another rectangular unit piece 16 arranged in contact with a long side 12 of the rectangular unit piece 11 but coincide with the vertexes of a further rectangular unit piece 18 arranged in contact with a short side 13 of the rectangular unit piece 11. In the array structure of the rectangular unit pieces, therefore, the vertex coincidence ratio is 66.6%.

Meanwhile, in FIG. 3, the rectangular unit pieces are arranged such that an island-type residue 110 is formed among the adjacent four rectangular unit pieces 200, 210, 220, and 230 (see a circle drawn by an alternated long and short dash line). The island-type residue 110 is an approximately rectangular residue defined by the respective sides of the rectangular unit pieces 200, 210, 220, and 230. This structure is not seen from the array structures of FIGS. 1 and 2 at all.

In the array structure of the rectangular unit pieces as described above, the utilization of the base material sheet 10 is greater than that in FIG. 1. Preferably, the effective width W of the base material sheet 10 is substantially almost equal to the cutting width D.

Also, a cutting margin 120 having a size less than that of the island-type residue 110 is located between the rectangular unit pieces 200 and 210, which are adjacent to each other at one side of each rectangular unit piece. Consequently, when the rectangular unit pieces 200, 210, 220, and 230 are cut from the base material, the respective rectangular unit pieces 200, 210, 220, and 230 are effectively cut as independent unit pieces by the cutters of the cutting frame.

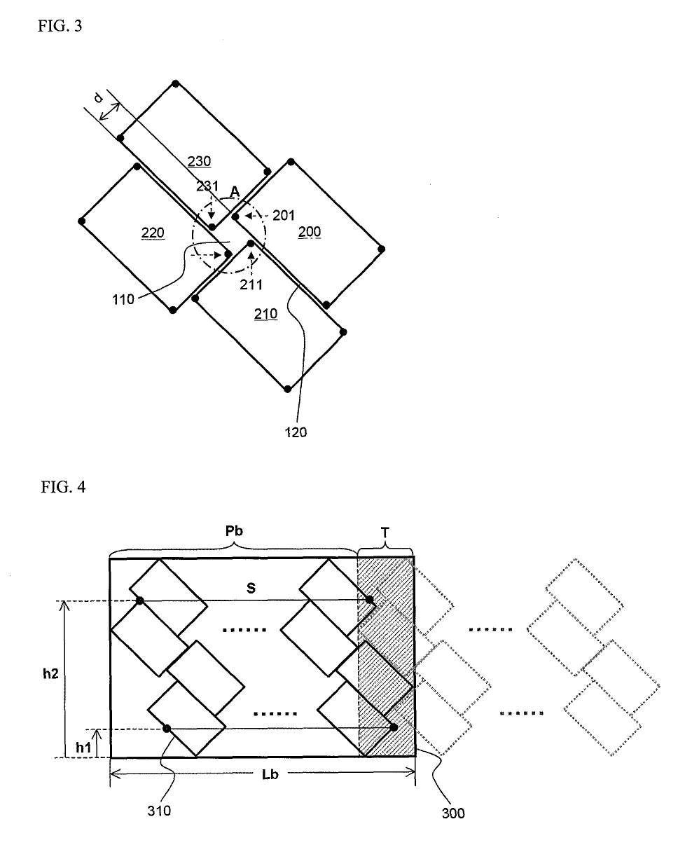

FIG. 4 is a typical view illustrating a cutting frame according to a preferred embodiment of the present invention. For convenience of description and simplicity of expression, the FIG. 4 partially illustrates the array structure of cutters to cut one kind of rectangular unit pieces.

Referring to FIG. 4, a plurality of cutters 310 are mounted or formed in the cutting frame 300. Rectangular unit pieces are cut from a base material sheet according to the array structure of the cutters 310.

The cutters 310 are arranged such that the shape of the right end cutters coincides with the shape of the left end cutters, i.e., the cutters 310 engage with one another when the right end cutters are successively followed by the left end cutters. In this array structure, the spacing distances S between the opposite-side end cutters in the longitudinal direction at arbitrary heights h1 and h2 from the lower end of the cutting frame 300 are the same.

Consequently, a pitch Pb, which is a distance for a one-time cutting process, is decided by the spacing distance S between the opposite-side end cutters at the arbitrary heights h1 and h2. The pitch Pb is less than the length Lb of the cutting frame. As a result, an overlap region T, which is a region obtained by subtracting the pitch Pb from the length Lb of the cutting frame 300, is used at the next cutting process, thereby achieving the optimum cutting efficiency in the longitudinal direction of the base material.

Also, although not clearly shown in FIG. 4, all the rectangular unit pieces located in the longitudinal direction (X-axis direction: horizontal direction) of the cutting frame 300 are arranged such that the upper end heights of the rectangular unit pieces are the same. For this reason, marking may be easily carried out with respect to the rectangular unit pieces simultaneously with the cutting or after the cutting in order to distinguish between the upper and lower sides of the cut rectangular unit pieces.

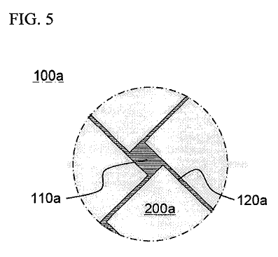

FIG. 5 is a typical view partially illustrating the shape of a scrap according to a preferred embodiment of the present invention.

Referring to FIG. 5, the scrap 100a is obtained after cutting a plurality of rectangular unit pieces from a base material according to the array structure of the rectangular unit pieces as shown in FIG. 3. Specifically, when the base material is sequentially cut by a cutting frame including the array structure of the rectangular unit pieces as shown in FIG. 3, it is possible to obtain the scrap 100a in which a plurality of bores 200a corresponding to the rectangular unit pieces are continuously connected to one another by a cutting margin 120a, and the rectangular unit piece bores 200a are adjacent to other rectangular unit piece bores at four sides of each rectangular unit piece bore such that the rectangular unit piece bores are spaced apart from one another by the cutting margin 120a.

Also, an island-type residue 110a having a size greater than that of the cutting margin 120a is formed among the adjacent four rectangular unit piece bores 200a of the scrap 100a.

### INDUSTRIAL APPLICABILITY

As apparent from the above description, the cutting frame according to the present invention exhibits the minimum cutting loss ratio through a unique and regular array structure of rectangular unit pieces when the rectangular unit pieces, of which the direction particularity is required according to the properties of a material, are to be cut from a base material while the rectangular unit pieces are inclined to the base material. In particular, when a large amount of rectangular unit pieces are produced through mass production, it is possible to greatly reduce the total manufacturing costs of the rectangular unit pieces based on the low cutting loss ratio.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cutting frame including a plurality of cutters for cutting one or more kinds of rectangular unit pieces having a relatively small size from a rectangular base material at a predetermined inclination, the cutters being mounted or formed in the cutting frame such that the cutters correspond to the rectangular unit pieces, wherein
the cutters are mounted or formed in the cutting frame in an array structure of the rectangular unit pieces in which the rectangular unit pieces adjacent to one another at each side thereof have a vertex coincidence ratio equivalent to less than 50%.

2. The cutting frame according to claim 1, wherein, when one kind of the rectangular unit pieces are cut, the vertex coincidence ratio is 0%.

3. The cutting frame according to claim 1, wherein the non-coincidence of the neighboring vertexes is such that x and y values (Ax, Ay) of one rectangular unit piece (A) have a deviation equivalent to 0.5% or more of an effective width of the base material from x and y values (Bx, By) of another rectangular unit piece (B) adjacent to the rectangular unit piece (A) at one side thereof in an array coordinate system of the rectangular unit pieces.

4. The cutting frame according to claim 1, wherein the base material is a continuous material having a predetermined width and a relatively very long length.

5. The cutting frame according to claim 1, wherein the rectangular unit pieces are inclined at an angle of 20 to 70 degrees.

6. The cutting frame according to claim 1, wherein the base material is a film including layers (‘absorption layers or transmission layers’) that absorb or transmit only a specific-direction wave motion of light or an electromagnetic wave in the longitudinal direction or in the lateral direction, and each of the rectangular unit pieces cut from the base material is a relatively small-sized film of which the absorption layers or the transmission layers are inclined at an angle of 45 degrees.

7. The cutting frame according to claim 1, wherein each of the cutters is a knife for cutting or a light source for cutting.

8. The cutting frame according to claim 1, wherein all the rectangular unit pieces located in the longitudinal direction (X-axis direction: horizontal direction) of the base material are arranged such that the upper end heights of the rectangular unit pieces are the same.

9. The cutting frame according to claim 8, wherein the rectangular unit pieces are arranged such that the distances between the leftmost end rectangular unit pieces and the rightmost end rectangular unit pieces at heights from a lower end of the cutting frame are the same irrespective of the heights.

10. The cutting frame according to claim 9, wherein the cutting frame is constructed such that the left boundary shape of the rectangular unit pieces coincides with the right boundary shape of the rectangular unit pieces.

11. A scrap obtained after cutting one or more kinds of rectangular unit pieces from a base material at a predetermined inclination,
wherein a plurality of bores corresponding to the rectangular unit pieces are continuously connected to one another by a cutting margin, and the rectangular unit piece bores are arranged such that the rectangular unit piece bores adjacent to one another with a cutting margin corresponding to each side of the rectangular unit piece bores have a vertex coincidence ratio equivalent to less than 50%.
